(19) United States
(12) Patent Application Publication
(10) Pub. No.: US 2017/0185989 A1
(43) Pub. Date: Jun. 29, 2017

(54) SPLIT GROUP PAYMENTS THROUGH A SHARABLE UNIFORM RESOURCE LOCATOR ADDRESS FOR A GROUP

(71) Applicant: PAYPAL, INC., San Jose, CA (US)

(72) Inventor: David Paul Bozovich, JR., San Jose, CA (US)

(21) Appl. No.: 14/981,758

(22) Filed: Dec. 28, 2015

(51) Int. Cl. G06Q 20/22; G06F 17/30; G06Q 20/10

(52) U.S. Cl. CPC G06Q 20/29; G06Q 20/102; G06F 17/30887

(57) ABSTRACT

There are provided systems and methods for split group payments through a sharable uniform locator address for a group. A group of payee users may be owed money by another payer user or group of other payer users. The group of payees may request a payment provider to generate a uniform resource locator (URL) address for the group that directs the payer(s) to a payment interface for providing a payment to the payees through the payment provider. Additionally, the payees may provide a payment breakdown for the group payment, which includes a share of the group payment owed to each payee, The payment provider may generate a URL address for the payment interface, which may be provided to the payers to direct the payers to the payment interface for the group payment. The payers may then provide a payment request using the payment interface.

### TECHNICAL FIELD

The present application generally relates to uniform resource locators and payment interfaces and more specifically to split group payments through a sharable uniform locator address for a group.

### BACKGROUND

Groups of users may purchase items together and wish to receive payment from other groups of users. For example, clubs may purchase food, drinks, sporting goods, or other items that are shared between the members of the group. Often a few of the collective group perform the purchasing on behalf of the whole group, and seek repayment from all the members of the group. This process is often tedious, where the few members that paid for the purchases are required to figure out each of their respective costs and how much each other user in the group owes the based on their costs. This can be confusing and may lead to double payments and/or incorrect calculations. Other times, the members that paid for the items may request money from all members, and then are required to split the money themselves. However, this method involves multiple transactions and a shared pool or fund for the members requiring payment.

### BRIEF DESCRIPTION OF THE DRAWINGS

FIG. 1 is a block diagram of a networked system suitable for implementing the processes described herein, according to an embodiment;

FIG. 2A is an exemplary screenshot of a payee device establishing a group payment request and viewing payments made by payers for the group payment request, according to an embodiment;

FIG. 2B is an exemplary screenshot of a payer device receiving a group payment request and navigating to a group payment interface to provide payments for the group payment request, according to an embodiment;

FIG. 3 is an exemplary system environment showing a communication device for a payee of a group of payees establishing a URL address with a payment provider server for communication to a communication device for a payer, according to an embodiment;

FIG. 4 is a flowchart of an exemplary process for split group payments through a sharable uniform locator address for a group, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for split group payments through a sharable uniform locator address or uniform resource locator (URL) for a group. Systems suitable for practicing methods of the present disclosure are also provided.

A group of users may wish to receive payment from one or more other users based on a debt owed to the group of users. The group of users receiving payment from one or more other users is referred to herein as a group of payees and/or payees. Conversely, the user or users providing a payment to the payees is referred to herein as a payer, group of payers, and/or payers. The payees may purchase items for the group, where the payees may then expect payback from the payers. In various embodiments, the payees may also expect payback from other payees, for example, if one payee provides more funds to the purchase than other payees. In other embodiments, other types of payments may be required, such as enrollment/registration fees or other type of costs typically associated with a group (e.g., an athletic/social club, group of friends, family, etc.). In order to receive payment from the payer(s), the payees may utilize a payment provider, which may provide payment services to users and merchants. The payment provider may provide for transfers, payments, and other financial services between two or more entities. Additionally, the payment provider may use an application and/or website to provide the financial services and processes.

In this regard, a computing device for the payer(s) and/or payees may include a payment application as one of the device applications, which may be configured to send and receive payments to another party, such as another user and/or a merchant. In certain embodiments, the payment application may correspond to a web browser application configured to access a website for the payment provider. For example, the payment application may be associated with a payment provider, such as PayPal® or other online payment provider service, which may provide payments and other financial services on behalf of a user (e.g., the payer(s) and/or payees). Thus, the user may utilize the payment application to send and/or receive payments between the user and another user/merchant. The online payment provider may provide such services through the payment application and data sent and received over a network connection between the online payment provider and a device executing the payment application. Additionally, the online payment provider may provide payment accounts and digital wallet services, which may offer financial accounts to send, store, and receive money, process financial instruments, and/or provide transaction histories. The online payment provider may offer further services, such as extension of credit, credit history review, and other financial and personal services.

The payment application may therefore provide one or more processes and features for use of the services provided by the online payment provider. When desiring to establish a group payment to the payees, one or more of the payees may request for the payment provider to establish a group payment process available on a payment interface of the payment application. The group payment process may therefore be accessible by the payer(s) through the payment interface so that the payer(s) may provide all or part of the group payment to the payees. The payment interface may be presented through the payment application, which may correspond to an interface of a dedicated payment application for the payment provider and/or a webpage of a website for the payment provider. In order to access the payment interface, the payment provider may generate an address, hyperlink, or other directory information for the payment interface that allows the payer(s) to navigate to the payment interface through a device and provide all or part of the group payment. Thus, the payment provider may provide one or more interfaces for receipt of information for the group payment, such as a group name, email addresses for users in the group (which may be imported from a contact list), selection of payment splitting (e.g., percentage owed by each payer/payee), images or other identifiable information for the group, and/or other additional information.

In this regard, the payment provider may generate a Uniform Resource Locator (URL) address that directs the user to the webpage for a website of the payment provider that hosts the payment interface. In other embodiments, the URL address may be used to initiate a process to cause the payment interface for the group payment to be opened in a payment application of a device for the user. Generally, the URL address may include a website address that identifies a website of the payment provider and further information directing a device to a webpage of the website. The URL address may further be identifiable by a user as identifying a group payment. For example, the URL address may be structured as www.paymentprovider.us/group 1. In this regard, the URL address includes a hostname (e.g., www.paymentprovider.us), as well as a file name or path for the webpage (e.g., group1). The file name or path may be determined from an entered group name. The URL address generated by the payment provider may also include a protocol or other information (e.g., http for webpages). However, in other embodiments, information such as the protocol may be automatically added in by a web browser when directing the web browser to a webpage. The hostname may generally identify the website of the payment provider (e.g., through paymentprovider.us), and may further identify the website as a group payment website (e.g., through the domain name .us, although other domain names such as .com may be used where the hostname may include identification of the group payment website elsewhere). Additionally, the file name/path or other address information may be used to identify the payment interface particular to the group payment owed to the payees (e.g., through/group1). However, in other embodiments, the URL address does not necessarily identify that the address is used for group payments, and navigation to the URL address by the payers may be required to identify the group payment interface.

The payment interface accessible through the URL address may include information for the group payment to the payers. For example, the payment interface may include an amount owed to the payees. The payment interface may also include information identifying the payees (e.g., names, payment account identifiers, images, group information, etc.) and information identifying the nature of the payment owed to the payees (e.g., for items purchased by the payees, fees due to the payees, payment plans of the payer(s) for an item or service, credit extended to the payer(s) by the payees, etc.). The payment interface may further include a process to initiate a payment to the payees by an individual payer. For example, the process may allow a payment or transfer to the payees by an individual payer. The payment process may utilize a payment account for the payer performing the payment, as well as payment accounts for the group and/or payees, as discussed herein. The payment process by the payment provider may allow the payer to perform a single payment/transfer, or may allow the payer to perform multiple transactions for payments/transfers to the payees. The payment interface may be communicated to the group using provided email addresses to the payment provider.

The payment interface may display an amount owed to the payees by the payers, which may display an entire balance owed to the payees by all of the payers or an amount owed by the individual payer. For example, where the payees are owed $300 total by a group of four payers, the payment interface may display that $300 is owed to the payees by the group of payers. The payment interface may also display a breakdown of each payers required payment, such as $75 where the required payment is split evenly between the four payers. However, where each payer owes a different amount to the total group payment, the payment interface may display the amount owed by each individual payer. In various embodiments, the total amount for the group payment and/or the amount owed by each individual payer may be redacted from the payment interface. Moreover, in certain embodiments, the payment shown in the payment interface and processed through the payment process may only display the amount owed by the individual payer. For example, the group of 4 payers may only view $75 owed to the payers in the payment interface where the group payment is evenly split, and may only contribute $75 to the group payment through the payment process. The payees may provide the information on the group payment amount owed to the payees and the amount owed by each payer to the group payment amount. The payment interface may also display each payee's costs and/or amount received from the group payment. The payees may also stipulate what payment information is displayed to the payer(s) on the payment interface. Thus, the payment provider may provide a payment amount owed by a payer on accessing the payment interface by the payer.

The payment interface may allow the payer(s) to login to a payment account with the payment provider to effectuate a payment from the payer(s) to the payees. A payment account may include information for the payer(s), such as payment instruments or other financial information. The payment account may further include user information, such as personal information, account identifiers, account security information, and/or other information. The payment interface may therefore include a login process, such as entry of an account name and a password, or other authentication information. Where a payer does not have an account with the payment provider, the payment interface may allow the payer to establish a payment account with the payment provider, for example, through an account setup process accessible through the payment interface. In other embodiments, the payment interface may include fields for entry of other payment information, such as a debit card, credit card, banking account with a financial institution, gift card, or other type of payment instrument. Moreover, when establishing the group payment, the payees may provide account information for each payee's payment account with the payment provider. However, if a payee does not have a payment account, the payment provider may allow the payee to establish a payment account and/or provide other financial information to deposit part of the group payment to a financial instrument (e.g., bank account) of the payee.

In various embodiments, the payees may provide a payment account or financial instrument to receive part of the group payment for each individual payee. Thus, the payees may receive deposits/payments from the group payment directly to their payment account and/or other financial instrument from the group payment. The payment/deposits may be received as a portion of the group payment each time a payer provides a payment for the group payment. However, in other embodiments, the payment provider may hold the amount paid by each payer until either the total amount for the group payment is received by the payment provider and/or disbursement of the group payment is requested by one or more of the payees. Where the group payment is not met by the payers, the amount may be refunded to the payers or the partial group payment may be disbursed to the payees. Moreover, the payer(s) may be reminded of the amount due by the payer(s) where the payer(s) have not yet paid their amount owed. In other embodiments, in order to receive payments, the payees may also establish a group payment account for the group payment. The group payment account may be accessible by one or more of the payees and may hold the payments/transfers by the payer(s). Each payee may request a disbursement of the amount they are owed from the group payment account, or the group payment account may automatically disburse payments to the payee's payment accounts or financial instruments.

The payees may stipulate to the amount owed to each payee for the group payment. The amount owed to each payee may be established on establishment of the URL address for the payment interface for the group payment. The amount owed to each payee from the group payment may be evenly split from the group payment. However, in other embodiments, the amount disbursed to each payee from the group payment may otherwise be set by the payees, such as an uneven split where certain payees are owed less money and/or contributed less to the group purchase. Moreover, in certain embodiments, the payees may provide receipts or other transaction histories for items purchased by the payees that require reimbursement from the payers in the group. In such embodiments, the payment provider may utilize the transaction histories to generate a group payment and/or calculate each individual payee's portion of the group payment.

The URL address for the payment interface of the group payment may be transmitted to the payees and/or payer(s). The URL address may include text and/or characters as the address, and may include a hyperlink in various embodiments. The payees may receive the URL address and may communicate the URL address to each payer using SMS/MMS messaging, instant messaging using a messaging platform, email, social networking, microblogging, or other messaging protocol. In other embodiments, the payees may provide contact information for the payer(s), and the payment provider may communicate the URL address to the payer(s) using a messaging protocol. The URL address may further be provided to additional payers and/or payees through further messages, and may be copied, pasted, and/or entered to another message by the payees and/or payers.

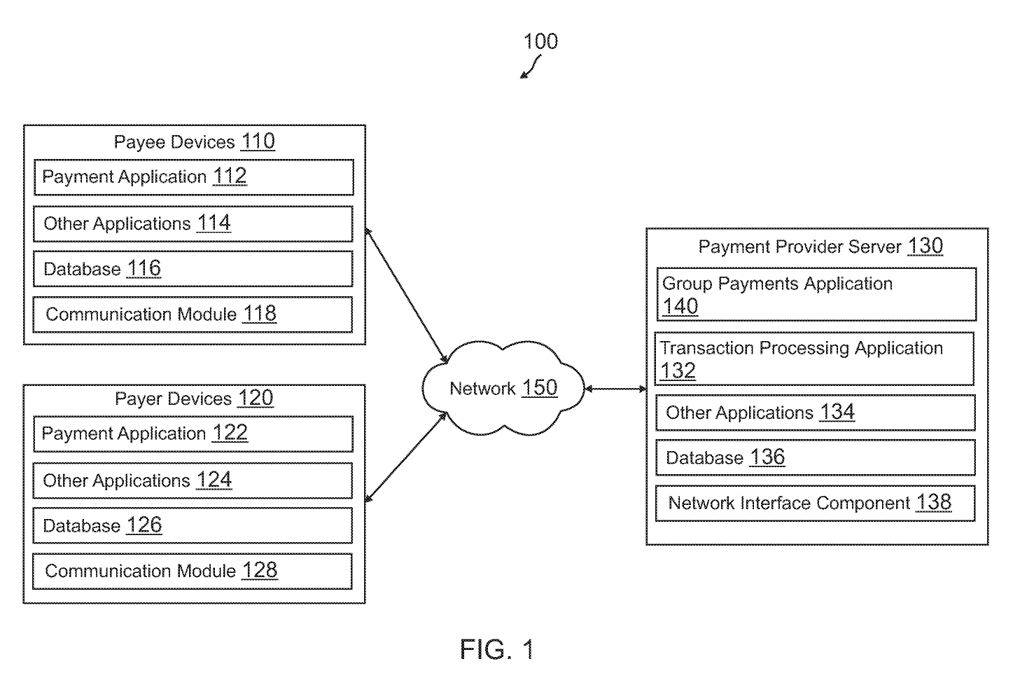

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes payee devices 110, payer devices 120, and a payment provider server 130 in communication over a network 150. A group of payees requiring payment from one or more payers may utilize payee devices 110 to utilize the various features available for payee devices 110, which may include payment processes and/or applications associated with receiving an amount for the group payment owed to the payees. The payer(s) owing an amount for the group payment may utilize payer devices 120 to utilize the various features available for payer devices 120, which may include payment processes and/or applications associated with providing the amount owed by the payers for the group payment. In this regard, payment provider server 130 may be used to establish a URL address for a payment interface of payment provider server 130 that may be used to provide payments/transfers for the group payment. The URL address may allow the payees and payers to access the payment interface using payee devices 110 and payer devices 120, respectively.

Payee devices 110, payer devices 120, and payment provider server 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Payee devices 110 may be implemented as a communication device that may utilize appropriate hardware and software configured for wired and/or wireless communication with payer devices 120 and/or payment provider server 130. For example, in one embodiment, payee devices 110 may be implemented as a personal computer (PC), telephonic device, a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although a communication device is shown, the communication device may be managed or controlled by any suitable processing device. Although the communication devices are described in plurality, a single device may perform the same functions and be utilized by the group of payees (e.g., a single family device shared by a family).

Payee devices 110 of FIG. 1 contain a payment application 112, other applications 114, a database 116, and a communication module 118. Payment application 112 and other applications 114 may correspond to executable processes, procedures, and/or applications with associated hardware. In other embodiments, payee devices 110 may include additional or different modules having specialized hardware and/or software as required.

Payment application 112 may correspond to one or more processes to execute software modules and associated devices of payee devices 110 to enter one or more payment instruments or other funding sources for storage in a digital wallet associated with a payment account (e.g., stored and/or serviced by payment provider server 130), access the digital wallet and/or payment account for use, and send and/or receive payments, including establishment and receipt of group payment for a group of payees. In this regard, payment application 112 may correspond to specialized hardware and/or software utilized by a user of payee devices 110 that provides an interface to permit payee users to enter input and other data for payment instruments, for example, through an input device (e.g., touch screen with a graphical user interface displayed by payment application 112, keypad/keyboard, mouse, etc.) and/or through a data capture device (e.g., scanner, camera, other optical device, etc.) In various embodiments, information for the payment account may also be stored to payee devices 110 for use in an offline environment. The payment account accessible through payment application 112 may be used to initiate, receive, and/or process/complete transactions, including receipt of deposits into a financial account from a group payment, using services provided by payment provider server 130. Once entered, the payment instruments may be communicated to payment provider server 130 over network 150 by payment application 112 for establishment and/or maintenance/update of the payment account and/or entry into the digital wallet. Additional benefits may be stored to the payment account, such as rewards programs, rewards programs membership level, rewards program points, available items in at least one rewards program, cash-back amounts for the at least one rewards program, airline miles, promotional credit, promotional credit rates, promotional discount rate, merchant discounts, merchant discount rates, and merchant coupons.

Payment application 112 may be implemented as a user interface enabling the user to select and provide payment. In various embodiments, payment application 112 may include a general browser application configured to retrieve, present, and communicate information over the Internet (e.g., utilize resources on the World Wide Web) or a private network. For example, payment application 112 may provide a web browser, which may send and receive information over network 150, including retrieving website information (e.g., a website for payment provider server 130) through a URL address provided by payment provider server 130, presenting the website information to the user, and/or communicating information to the website, including payment information for payment through payment provider server 130. In various embodiments, a displayed webpage may correspond to a payment interface for a group payment owed to the payee users utilizing payee devices 110. However, in other embodiments, payment application 112 may include a dedicated application of payment provider server 130 or other entity (e.g., a merchant), which may be configured to provide payment account services and process financial transactions. Thus, a payment interface for the group payment may also be opened in the dedicated application, for example, using a URL address that causes opening/loading of the payment interface or other communicable information causing opening of the payment interface.

Payment application 112 may be utilized to select payment instrument(s) for use in providing payment for a transaction, transfer, or other financial process. As discussed herein, payment application 112 may utilize user financial information, such as a credit card, bank account, or other financial account, as a payment instrument when providing payment information. Additionally, payment application 112 may utilize a user account with payment provider, such as payment provider server 130, as the payment instrument. Selection of a payment instrument may occur prior to, at, or after establishment of the financial process. Payment provider server 130 may then use the payment instrument during processing of payment, as discussed herein with respect to payment provider server 130. Payment application 112 may be utilized to view the results of payment, for example, using transaction histories, dispute resolution processes, and other post-transaction process.

Payment application 112 may also be used to establish a payment interface for a group payment owed to the payee users utilizing payee devices 110. In this regard, payment application 112 may access a website, application interface, or other form having fields for entry of group payment information. The group payment information may include identification of the payees, the payers owing payment to the payees, an amount of the group payment, an amount owed by each of the payers to the payees, an amount owed to each of the payees from the group payment, a reason for the group payment, and/or other group payment information. The group payment information may be used to establish the group payment, as discussed herein. Once established, payment application 112 may receive the URL address for the group payment. In various embodiments, payment application 112 may be used to specify all or part of the URL address used to retrieve the payment interface for the group payment. Payment application 112 may be further used to access the group payment and/or group payment account, for example, to change/update the group payment, request disbursement of the group payment according to the amounts owed to each payee, add additional amounts to the group payment and/or reduce the amount of the group payment, or other function associated with the group payment. Payment application 112 may be used to communicate a URL address to another user, such as a payer.

In various embodiments, payee devices 110 include other applications 114 as may be desired in particular embodiments to provide features to payee devices 110. For example, other applications 114 may include security applications for implementing client-side security features, programmatic client applications for interfacing with appropriate application programming interfaces (APIs) over network 150, or other types of applications. Other applications 114 may also include email, texting, voice and IM applications that allow a user to send and receive emails, calls, texts, and other notifications through network 150. In various embodiments, other applications 114 may include financial applications, such as banking, online payments, money transfer, or other applications. Other applications 114 may also include other location detection applications, which may be used to determine a location for the user, such as a mapping, compass, and/or GPS application, which can include a specialized GPS receiver that obtains location information for payee devices 110 and processes the location information to determine a location of payee devices 110 and the user. Other applications may include social networking applications, media viewing, and/or merchant applications. Other applications may be used to communicate a URL address to a payer or other user (e.g., payer devices 120).

Other applications 114 may also be associated with other devices, such as biometric devices and other types of accessible or connected devices. Other applications 114 may include device interfaces and other display modules that may receive input from the user and/or output information to the user, For example, other applications 114 may contain software programs, executable by a processor, including a graphical user interface (GUI) configured to provide an interface to the user. Other applications 114 may therefore use devices of payee devices 110, such as display devices, including GUIs capable of displaying information to users and other output devices, including speakers. Payee devices 110 may include input devices, including touch screens. Payee devices 110 may include a sensor or other component used to collect the current information associated with the user, such as an input device, a camera, a microphone, an accelerometer, a motion detector, an environmental sensor, and/or a biometric sensor.

Payee devices 110 may further include database 116 stored to a transitory and/or non-transitory memory of payee devices 110, which may store various applications and data and be utilized during execution of various modules of payee devices 110. Thus, database 116 may include, for example, identifiers such as operating system registry entries, cookies associated with payment application 112 and/or other applications 114, identifiers associated with hardware of payee devices 110, or other appropriate identifiers, such as identifiers used for payment/user/device authentication or identification, which may be communicated as identifying payee devices 110 to payment provider server 130. Additionally, database 116 may store account information and/or account preferences for an account with payment provider server 130. Where applicable, information used by payment application 112 may be stored to database 116 (e.g., messaging information, emails, etc.). A URL address for a payment interface for a group payment may be stored to database 116.

Payee devices 110 includes at least one communication module 118 adapted to communicate with payer devices 120 and/or payment provider server 130. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with nearby devices using short range communications, such as Bluetooth Low Energy, LTE Direct, WiFi, radio frequency, infrared, Bluetooth, and near field communications.

Payer devices 120 may be implemented as a communication device that may utilize appropriate hardware and software configured for wired and/or wireless communication with payee devices 110 and/or payment provider server 130. For example, in one embodiment, payer devices 120 may be implemented as a personal computer (PC), telephonic device, a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although a communication device is shown, the communication device may be managed or controlled by any suitable processing device. Although the communication devices are described in plurality, a single device may perform the same functions and be utilized by the group of payees (e.g., a single family device shared by a family).

Payer devices 120 of FIG. 1 contain a payment application 122, other applications 124, a database 126, and a communication module 128. Payment application 122 and other applications 124 may correspond to executable processes, procedures, and/or applications with associated hardware. In other embodiments, payer devices 120 may include additional or different modules having specialized hardware and/or software as required.

Payment application 122 may correspond to one or more processes to execute software modules and associated devices of payer devices 120 to enter one or more payment instruments or other funding sources for storage in a digital wallet associated with a payment account (e.g., stored and/or serviced by payment provider server 130), access the digital wallet and/or payment account for use, and send and/or receive payments, including receipt of a URL address for group payment for a group of payees and processing of a payment by the payer(s) for the group payment. In this regard, payment application 122 may correspond to specialized hardware and/or software utilized by a user of payer devices 120 that provides an interface to permit payer users to enter input and other data for payment instruments, for example, through an input device (e.g., touch screen with a graphical user interface displayed by payment application 122, keypad/keyboard, mouse, etc.) and/or through a data capture device (e.g., scanner, camera, other optical device, etc.) In various embodiments, information for the payment account may also be stored to payer devices 120 for use in an offline environment. The payment account accessible through payment application 122 may be used to initiate, receive, and/or process/complete transactions, including providing payments for a group payment, using services provided by payment provider server 130. Once entered, the payment instruments may be communicated to payment provider server 130 over network 150 by payment application 122 for establishment and/or maintenance/update of the payment account and/or entry into the digital wallet. Additional benefits may be stored to the payment account, such as rewards programs, rewards programs membership level, rewards program points, available items in at least one rewards program, cash-back amounts for the at least one rewards program, airline miles, promotional credit, promotional credit rates, promotional discount rate, merchant discounts, merchant discount rates, and merchant coupons.

Payment application 122 may be implemented as a user interface enabling the user to select and provide payment. In various embodiments, payment application 122 may include a general browser application configured to retrieve, present, and communicate information over the Internet (e.g., utilize resources on the World Wide Web) or a private network. For example, payment application 122 may provide a web browser, which may send and receive information over network 150, including retrieving website information (e.g., a website for payment provider server 130) through a URL address provided by payment provider server 130, presenting the website information to the user, and/or communicating information to the website, including payment information for payment through payment provider server 130. In various embodiments, a displayed webpage may correspond to a payment interface for a group payment owed by the payer users utilizing payer devices 120. However, in other embodiments, payment application 122 may include a dedicated application of payment provider server 130 or other entity (e.g., a merchant), which may be configured to provide payment account services and process financial transactions. Thus, a payment interface for the group payment may also be opened in the dedicated application, for example, using a URL address that causes opening/loading of the payment interface or other communicable information causing opening of the payment interface.

Payment application 122 may be utilized to select payment instrument(s) for use in providing payment for a transaction, transfer, or other financial process. As discussed herein, payment application 122 may utilize user financial information, such as a credit card, bank account, or other financial account, as a payment instrument when providing payment information. Additionally, payment application 122 may utilize a user account with payment provider, such as payment provider server 130, as the payment instrument. Selection of a payment instrument may occur prior to, at, or after establishment of the financial process. Payment provider server 130 may then use the payment instrument during processing of payment, as discussed herein with respect to payment provider server 130. Payment application 122 may be utilized to view the results of payment, for example, using transaction histories, dispute resolution processes, and other post-transaction process.

Payment application 122 may also be used to access a payment interface for a group payment owed to the payee users utilizing payee devices 110 by the payer users utilizing payer devices 120. In this regard, payment application 122 may access a website, application interface, or location for the payment interface using a URL for the payment interface. The URL address may be entered to a field of payment application 122 or another application (e.g., a web browser application) and cause the opening/loading of the payment interface. The payment interface may include displayable information for the payees, the payers owing payment to the payees, an amount of the group payment, an amount owed by each of the payers to the payees, an amount owed to each of the payees from the group payment, a reason for the group payment, and/or other group payment information. Once the payment interface is opened in payment application 122, payment application 122 may be used to provide a payment to the payees use the processes described above (e.g., selection of a payment instrument and instruction to provide payment by payment provider server 130 to the payees using the selected payment instrument). Payment application 122 may be used to receive the URL address and/or reminders for payment of the portion owed of the group payment by a payer user.

In various embodiments, payer devices 120 include other applications 124 as may be desired in particular embodiments to provide features to payer devices 120. For example, other applications 124 may include security applications for implementing client-side security features, programmatic client applications for interfacing with appropriate application programming interfaces (APIs) over network 150, or other types of applications. Other applications 124 may also include email, texting, voice and IM applications that allow a user to send and receive emails, calls, texts, and other notifications through network 150. In various embodiments, other applications 124 may include financial applications, such as banking, online payments, money transfer, or other applications. Other applications 124 may also include other location detection applications, which may be used to determine a location for the user, such as a mapping, compass, and/or GPS application, which can include a specialized GPS receiver that obtains location information for payer devices 120 and processes the location information to determine a location of payer devices 120 and the user. Other applications may include social networking applications, media viewing, and/or merchant applications. Other applications may be used to receive a URL address from a payee (e.g., payee devices 110).

Other applications 124 may also be associated with other devices, such as biometric devices and other types of accessible or connected devices. Other applications 124 may include device interfaces and other display modules that may receive input from the user and/or output information to the user. For example, other applications 124 may contain software programs, executable by a processor, including a graphical user interface (GUI) configured to provide an interface to the user. Other applications 124 may therefore use devices of payer devices 120, such as display devices, including GUIs capable of displaying information to users and other output devices, including speakers. Payer devices 120 may include input devices, including touch screens. Payer devices 120 may include a sensor or other component used to collect the current information associated with the user, such as an input device, a camera, a microphone, an accelerometer, a motion detector, an environmental sensor, and/or a biometric sensor.

Payer devices 120 may further include database 126 stored to a transitory and/or non-transitory memory of payer devices 120, which may store various applications and data and be utilized during execution of various modules of payer devices 120. Thus, database 126 may include, for example, identifiers such as operating system registry entries, cookies associated with payment application 122 and/or other applications 124, identifiers associated with hardware of payer devices 120, or other appropriate identifiers, such as identifiers used for payment/user/device authentication or identification, which may be communicated as identifying payer devices 120 to payment provider server 130. Additionally, database 126 may store account information and/or account preferences for an account with payment provider server 130. Where applicable, information used by payment application 122 may be stored to database 126 (e.g., messaging information, emails, etc.). A URL address for a payment interface for a group payment may be stored to database 126.

Payer devices 120 includes at least one communication module 128 adapted to communicate with payee devices 110 and/or payment provider server 130. In various embodiments, communication module 128 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 128 may communicate directly with nearby devices using short range communications, such as Bluetooth Low Energy, LTE Direct, WiFi, radio frequency, infrared, Bluetooth, and near field communications.

Payment provider server 130 may be maintained, for example, by an online service provider, which may provide connection services on behalf of users. In this regard, payment provider server 130 includes one or more processing applications which may be configured to interact with payee devices 110, merchant device 150, and/or another device/server to facilitate connecting users having a shared interest. In one example, payment provider server 130 may be provided by PAYPAL®, Inc. of San Jose, Calif., USA. However, in other embodiments, payment provider server 130 may be maintained by or include another type of service provider, which may provide connection services to a plurality of users.

Payment provider server 130 of FIG. 1 includes a group payments application 140, a transaction processing application 132, other applications 134, a database 136, and a network interface component 138. Group payments application 140, transaction processing application 132, and other applications 134 may correspond to executable processes, procedures, and/or applications with associated hardware. In other embodiments, payment provider server 130 may include additional or different modules having specialized hardware and/or software as required.

Group payments application 140 may correspond to one or more processes to execute software modules and associated specialized hardware of payment provider server 130 to receive a request to establish a group payment, generate a payment interface and a URL address for accessing the payment interface, and distribute the URL to one or more payees and/or payers for processing of payments for the group payment. In this regard, group payments application 140 may correspond to specialized hardware and/or software to receive a request to establish a group payment from one or more payees through payee devices 110. The request may include information for the group payment, such as the names, identifiers, or other user information for each of the payees requiring reimbursement or payment, and/or group information for the group of payees requiring reimbursement or payment. In various embodiments, the request may further include group payment information, including an amount of the group payment and a reason for the group payment. In other embodiments, the payees may submit their expenses or requested payment amounts each, as well as reasons for the payees' payment requests, which may be used to generate the group payment. The request may include an amount or share of the group payment for each payee. However, if the share is not provided, group payments application 140 may evenly split the group payment or may determine a share for each payee (e.g., based on a transaction history or other information for the group payment). Such information may be requested through one or more interfaces including associated interface fields for entry of data. For example, the interfaces may include a field to enter a group name, an amount, a split percentage or split mechanism for the amount, email address or other contact information for the payers and/or payees, and/or images or other identifying information for the group.

Once the group payment request is received, group payments application 140 may generate a payment interface accessible by the payees and/or payers for the group payment. The payment interface may include information for the group payment (e.g., payment amount, payee share in the group payment, payment reason, payees, and/or other aforementioned group payment information). Additionally, the payment interface includes a payment process to provide a payment for the group payment by a payer. A payment may be effectuated using a payment instrument, such as a payment account with payment provider server 130. Where a payer does not already have a payment account, the payment interface may include a process to establish a payment account with payment provider server 130. Additionally, the payment interface may further accept other financial instruments to provide the payment, such as debit/credit cards, bank accounts, etc. Where provided, the payment interface may further include information for the individual payers, which may include names or identifiers for each of the payers. The payment interface may generally request a payment for each payer, or may split the payment between the payers to request a specific amount from each payer. Where an identifier and require payment share amount by specific payers is provided, the payment interface may further request a specific payment amount other than a split amount of the entire group payment.

Group payments application 140 may generate a URL address used to access the payment interface. For example, the URL address may direct a web browser program to a webpage for a payment website of payment provider server 130. In other embodiments, the URL address may cause a process to be initiated that opens/loads the payment interface to a payment interface in a dedicated application associated with payment provider server 130. The URL address may include a hostname field, as well as a file name or path. The file name or path may be generated from the group name. In various embodiments, additional information may be added to the URL address, such as a protocol or scheme, query, fragment, or other URL component. However, where the component is unnecessary for direction to the payment interface, the additional components may be entered by a web browser (e.g., http://). The URL address may be specific for the payment interface, and may include identification of payment provider server 130 as well as the group. Additionally, the group identification (e.g., the file name or path) may be configurable by the payees in the group payment request.

Once the URL address is generated, the URL address may be communicated to the payees and/or payers for the group payment. The payees may specify the payers, and group payments application 140 may communicate the URL address to a device for each payer (e.g., payer devices 120), for example using data transfers to payment application 122, SMS, MMS, email, instant messaging, social networking, or other communication protocol. In other embodiments, the URL address may be communicated to payees on payee devices 110, which may then message the URL address to one or more payers on payer devices 120 using the aforementioned communication channels. In various embodiments, payee devices 110 may also interface with payer device 120 over short range wireless communications (e.g., Bluetooth, Bluetooth Low Energy, LTE Direct, WiFi, radio, microwave, infrared, near field communications, etc.) to send the URL between the devices. A payer receiving the URL address may also further communicate the URL address to additional payers using the aforementioned communication channels.

Group payments application 140 may further be used to update the payment interface and/or URL address. The payment interface may be updated as a balance of the group payment is reduced from payments by payers. The payment interface may also be updated with additional group payments and/or payment requests, for example, if additional items are purchased by payers. Payees and/or payers may be added or removed from the payment interface. The URL may be changed based on a new group payment or updated group payment, and may be deleted where a group payment is satisfied or canceled. Group payments application 140 may further be used to request disbursement of amounts in the group payment and/or issued refunds for payments by payers. Information for payments by payers may be retrieved from transaction processing application 132.

Transaction processing application 132 may correspond to one or more processes to execute software modules and associated specialized hardware of payment provider server 130 to establish, maintain, and provide a payment account to a user (e.g., payee or payer) based on the user's payment instruments and provide payments using the payment account and/or payment instruments. In this regard, transaction processing application 132 may correspond to specialized hardware and/or software to receive information requesting establishment of the payment account. The information may include user personal and/or financial information. Additionally the information may include a login, account name, password, PIN, or other account creation information. The user may provide a name, address, social security number, or other personal information necessary to establish the account and/or effectuate payments through the account. Transaction processing application 132 may further allow the user to service and maintain the payment account, for example, by adding and removing payment instruments. Additionally, benefits received from merchant server 150 for connecting with another user may be stored and/or redeemed using transaction processing application 132.

Transaction processing application 132 may be used to provide a payment for a group payment, for example, between payee devices 110 and payer devices 120 using payment provider server 130. Transaction processing application 132 may debit an account of the payer automatically and provide the payment to an account of the payee. In other embodiments, transaction processing application 132 may hold payments made by payers for a group payment in escrow until disbursement is requested or the funding amount for a group payment is made. Moreover, a group payment account may be generated by transaction processing application 132, which may hold payments for the group payment until disbursement is requests or the group payment is made. The group payment account may be accessible by the payees for the group payment or may be accessible only by certain payees (e.g., group leaders). Transaction processing application 132 may also be used to provide transaction histories for processed transactions, payments, and transfers.

In various embodiments, payment provider server 130 includes other applications 134 as may be desired in particular embodiments to provide features to payment provider server 134. For example, other applications 134 may include security applications for implementing server-side security features, programmatic client applications for interfacing with appropriate application programming interfaces (APIs) over network 150, or other types of applications. Other applications 134 may contain software programs, executable by a processor, including a graphical user interface (GUI), configured to provide an interface to the user when accessing payment provider server 160, where the user or other users may interact with the GUI to more easily view and communicate information. In various embodiments, other applications 134 may include connection and/or communication applications, which may be utilized to communicate information to over network 150.

Additionally, payment provider server 130 includes database 136. As previously discussed, the user (payee or payer) and/or the group corresponding to payee devices 110 and payer devices 120 may establish one or more digital wallets and/or payment accounts with payment provider server 130. Digital wallets and/or payment accounts in database 136 may include user information, such as name, address, birthdate, payment instruments/funding sources, additional user financial information, user preferences, and/or other desired user data. Users may link to their respective digital wallets and/or payment accounts through an account, user, and/or device identifier. Thus, when an identifier is transmitted to payment provider server 130, e.g., from payee devices 110 and/or payer devices 120, one or more digital wallets and/or payment accounts belonging to the users may be found. Database 136 may also store group information, include group payment requests, generated payment interfaces and URL addresses, group payment information, group payment balances, and other information associated with a group payment.

In various embodiments, payment provider server 130 includes at least one network interface component 138 adapted to communicate payee devices 110 and/or payer devices 120 over network 150. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

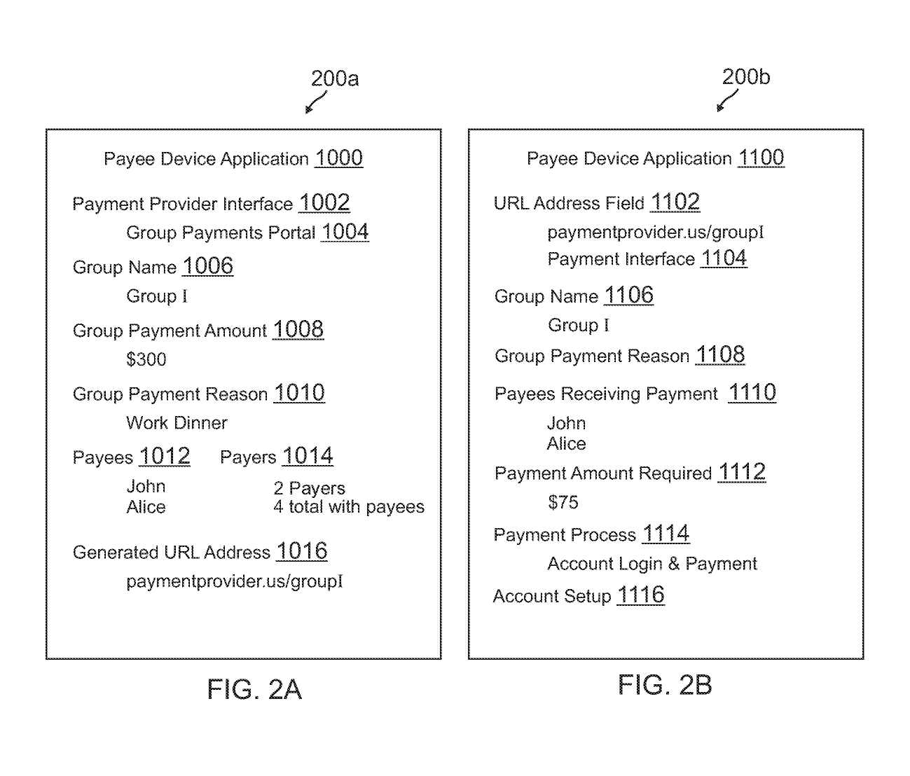

FIG. 2A is an exemplary screenshot of a payee device establishing a group payment request and viewing payments made by payers for the group payment request, according to an embodiment. Environment 200a includes a payee device application 1000 corresponding to an application executing on one of payee devices 110 in environment 100 of FIG. 1, such as a payment application 112.

In this regard, payee device application 1000 includes a payment provider interface 1002 configures to provide an application interface, such as a graphic user interface (GUI) of a web browser or dedicated application executing on a device. Payment provider interface 1002 may be linked to a payment provider, which may provide payment services to users, including groups of users having payees requesting payment from one or more payers. Thus, a payee viewing payee device application 1000 may have navigated to a group payments portal 1004 displayed on payment provider interface 1002 in order to establish a group payment made to the group of payees by one or more payers, which may be other members in a group with the payees or other potential payers. In order to establish the group payment receivable by the payees from the payer(s), the payee using payee device application 1000 may provide enter information to group name 1006, shown as “Group 1.” Group name 1006 may be used for identification of the group and/or group payment. The payee may further enter information to a field for a group payment amount 1008, shown as $300 that was paid by the group (or required payment by the payers). Using at least the aforementioned information, a group payment may be generated, which may utilize a payment interface accessible by a URL address.

Additional information may be entered to the group payments portal 1004 for generation of a group payment. For example, information for a group payment reason 1010 (e.g., “Dinner”) may be provided and entered to the payment interface. Group payment reason 1010 may serve to inform payers of the nature of the group payment. Similarly, the payee may enter payees 1012, which may include names, identifiers, and/or payment accounts for payees 1012 (e.g., John and Alice) to provide disbursement of payment for the group payment. In similar fashion, payers 1014 may include a number (e.g., 2 payers, 4 total with payees), a name, or an identifier, which may be used to distribute the payment interface and/or determine a cost breakdown for each user and required payment or received credit for each user. Once sufficient information is received to generate the payment interface for the group payment, a generated URL address 1016 may be determined, which may be presented as paymentprovider.us/group1.

FIG. 2B is an exemplary screenshot of a payer device receiving a group payment request and navigating to a group payment interface to provide payments for the group payment request, according to an embodiment. Environment 200b includes a payer device application 1100 corresponding to an application executing on one of payer devices 120 in environment 100 of FIG. 1, such as a payment application 122.

In this regard, payer device application 110 may display a payment interface accessed through the URL address determined in payment provider interface 1002 in environment 200a of FIG. 2A. For example, URL address field 1102 may be populated with the URL address, shown as paymentprovider.us/group1. Once entered, URL address field may cause navigation to a webpage and/or loading of an application interface having payment interface 1104 where the payer may provide a payment for the group payment. Thus, payment interface 1104 include information for display to the user, including a group name 1106 (e.g., “Group 1”) and a group payment reason 1108 (e.g., “Dinner”). Additionally, payment interface 1104 providing information for payees receiving payment 1110, such as payees John and Alice from FIG. 2A.

Using the group payment amount 1008 from FIG. 2A and payers 1014 from FIG. 2A, it may be determined that the total group of 4 payers (e.g., including the payees), each owe $75 to the $300 group payment amount 1008 from FIG. 2A. Thus, payment amount required 1112 displays $75 required from the payer viewing payment interface 1104. In order to provide the payment, the payer may utilize a payment process 1114, which may include an “Account Login and Payment.” However, where the payer does not have a payment account with the payment provider to enter to payment process 1114, the payer may utilize account setup 1116 in order to provide payments for the group payment.

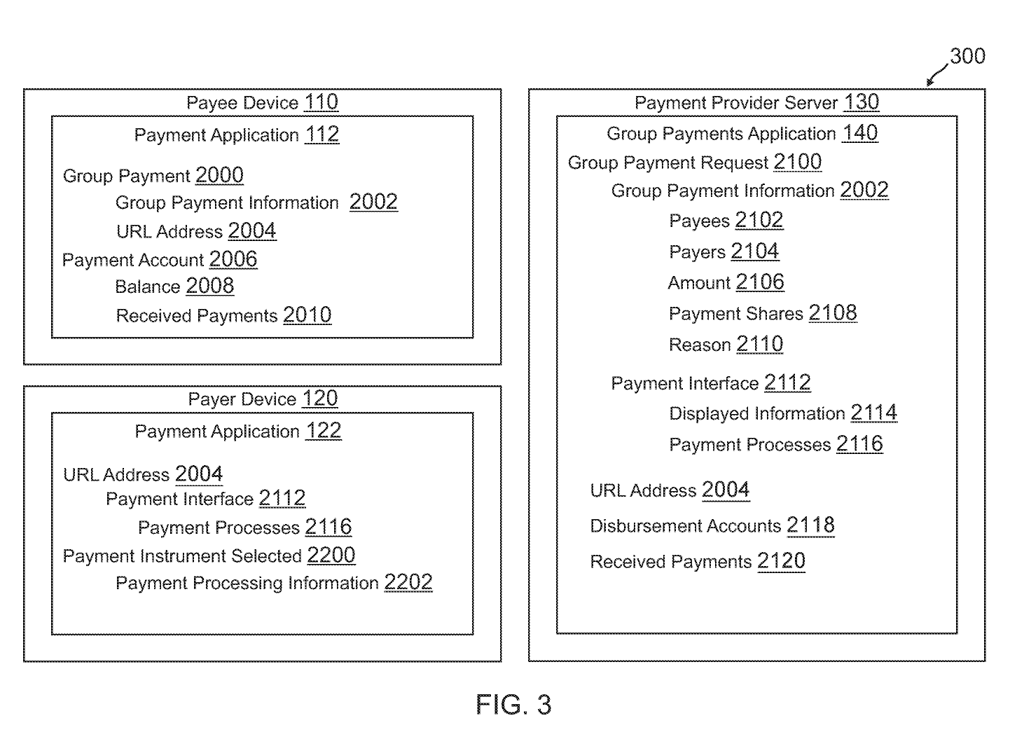

FIG. 3 is an exemplary system environment showing a communication device for a payee of a group of payees establishing a URL address with a payment provider server for communication to a communication device for a payer, according to an embodiment. FIG. 3 includes payee device 110, payer device 120, and a payment provider server 130 all discussed in reference to environment 100 of FIG. 1.

Payee device 110 executes payment application 112 corresponding generally to the specialized hardware and/or software modules and processes described in reference to FIG. 1. In this regard, payment application 112 is executed on a single payee device corresponding to payee devices 110 of FIG. 1 and includes a group payment 2000, which may have group payment information 2002. Group payment information 2002 may include various information for a group payment, which may include payees, payers, a group payment amount, a group payment reason, and/or other information for the group payment (e.g., payees shares of the group payment). Payment application 112 may further receive a URL address 2004 for group payment 2000. Moreover, payment application 112 may further include payment account 2006 for a payee using payee device 110. Payment account 2006 may include a balance 2008, as well as received payments 2010 that may include payments received for group payment 2000.

Payment provider server 130 executes group payments application 140 corresponding generally to the specialized hardware and/or software modules and processes described in reference to FIG. 1. In this regard, group payments application 140 may be used to establish a payment interface for group payment 2000 from payee device 110, and provide a URL address to access the payment interface. For example, group payments application 140 includes a group payment request 2100 for group payment 2000. For example, group payment information 2002 may be utilized to determine a payment interface 2112 by group payments application 140. Group payments information 2002 may include payees 2102 for group payment 2000, payers 2104 for group payment 2000, an amount 2106 for group payment 2000, payment shares 2108 for group payment 2000, and .a reason 2110 for group payment 2000. Using group payment information 2002, payment interface 2112 may be determined, which may include displayed information 2114 and payment processes 2116. Payment processes 2116 may include processes by payers 2104 to provide payments for group payment 2000. Additionally, group payments application 140 may determine URL address 2004, which may be communicated to one or more other devices to receive payments for group payment 2000. Moreover, group payments application 140 may associate disbursement accounts 2118 for group payment request 2100, which may receive transfers of received payments 2120.

Payer devices 120 executes payment application 122 corresponding generally to the specialized hardware and/or software modules and processes described in reference to FIG. 1. In this regard, payment application 122 is executed on a single payer device correspond to payer devices 120 of FIG. 1 and includes URL address 2004 used to access a payment interface and provide payments for group payment 2000. Thus, URL address is used to access payment interface 2112 and utilize payment processes 2116 to provide one or more payments for group payment 2000. Moreover, payment application 122 may further include a payment instrument selected 2200, which may include a payment account with payment provider server 130. Moreover, payment application 122 may provide payment processing information 2202, such as a transaction history for a payment for group payments 2000.

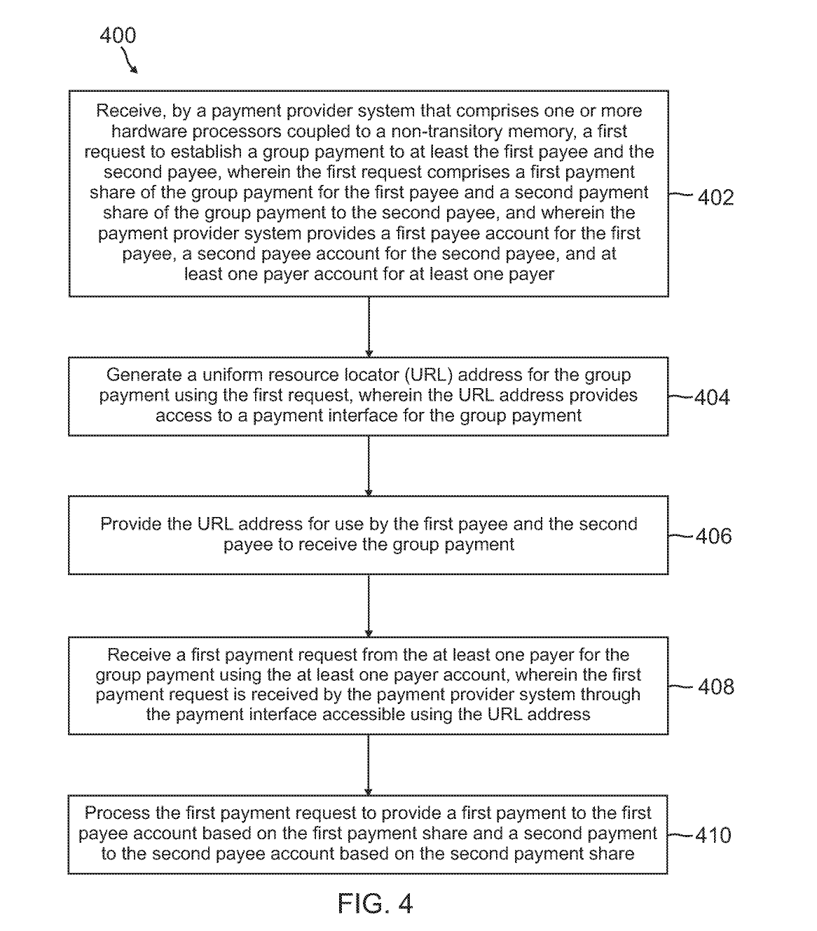

FIG. 4 is a flowchart of an exemplary process for split group payments through a sharable uniform locator address for a group, according to an embodiment. Note that one or more steps, processes, and methods described herein may be omitted, performed in a different sequence, or combined as desired or appropriate.

At step 402, a first request to establish a group payment to at least the first payee and the second payee is received, by a payment provider system that comprises one or more hardware processors coupled to a non-transitory memory, wherein the first request comprises a first payment share of the group payment for the first payee and a second payment share of the group payment to the second payee, and wherein the payment provider system provides a first payee account for the first payee, a second payee account for the second payee, and at least one payer account for at least one payer. In various embodiments, the at least one payer account comprises a debit card, a credit card, and a banking account with a financial institution other than the payment provider system. The first payment share and the second payment share may be equal by default in the first request, wherein the payment provider system provides a group payment interface to adjust a first amount of the first payment share and a second amount of the second payment share. In other embodiments, the first payment share and the second payment share may be determined using a payment breakdown for at least one item purchased by the first payee and the second payee, wherein the payment breakdown comprises a first contribution to the at least one item by the first payee and a second contribution to the at least one item by the second payee.

A uniform resource locator (URL) address for the group payment using the first request is generated, wherein the URL address provides access to a payment interface for the group payment, at step 404. The URL address may comprise a web address for a payment webpage on a website of the payment provider system, wherein the payment interface of the payment webpage displays information for the group payment, and wherein the payment interface includes a payment processing field to submit the first payment request. In other embodiments, the URL address causes an application interface to be opened in a dedicated application of the payment provider system executing on a device of the at least one payer, wherein the payment interface in the application interface displays information for the group payment, and wherein payment interface includes a payment processing field to submit the first payment request using the dedicated application. In various embodiments, at least one further group payment for a second item for the group payment may be received, wherein payment interface is updated with a further group payment for the second item. The payment interface may comprise a setup process to establish payment accounts with the payment provider system, and wherein the at least one payer uses the setup process to establish the at least one payer account used to submit the first payment request.

At step 406, the URL address is provided for use by the first payee and the second payee to receive the group payment. Providing the URL address may comprise communicating the URL address to at least one of the first payee and the second payee, and wherein the at least one of the first payee and the second payee communicates the URL address to the at least one payer for payment. For example, at least one of the first payee and the second payee may communicate the URL address from a first device of the at least one of the first payee and the second payee to a second device of the at least one payer using one of SMS messaging, MMS messaging, email, instant messaging, social networking messaging, microblogging, and short range wireless communications. In other embodiments, providing the URL address may comprise communicating the URL address to the at least one payer by the payment provider system on request by at least one of the first payee and the second payee.

A first payment request from the at least one payer for the group payment using the at least one payer account is received, wherein the first payment request is received by the payment provider system through the payment interface accessible using the URL address, at step 408. The at least one payer may comprise a plurality of payers, wherein the at least one payer account comprises a plurality of payer accounts for the plurality of payers, wherein each of the plurality of payers owes a portion of the group payment, and wherein the first payment request is for a first amount owed by a first payer of the plurality of payers. Thus, a second payment request from a second payer based on a second amount owed by the second payer may be received and processed.

At step 410, the first payment request is processed to provide a first payment to the first payee account based on the first payment share and a second payment to the second payee account based on the second payment share. A group payment account for the group payment may be established, and the first payment request may be processed to receive a deposit for the first payment and the second payment in the group payment account. The first payee and the second payee may be provided access to the group payment account by the payment provider system, wherein the first payee is allowed to withdraw up to the first payment share from the deposit in the group payment account, and wherein the second payee is allowed to withdraw up to the second payment share from the deposit the in group payment account. In various other embodiments, processing the first payment request may further comprise transferring the first payment for the first payment share to the first payee account from the group payment account and transferring the second payment for the second payment share to the second payee account from the group payment account.

In various embodiments, a second payment request from at least one additional payer for the group payment is received, and the second payment request is processed to provide a third payment to the first payee account based on the first payment share and a fourth payment to the second payee account based on the second payment share. Further embodiments may include receiving a second request to change the first payment share and the second payment share, updating the first payment share to a first new shared amount of the group payment, and updating the second payment share to a second new shared amount of the group payment.

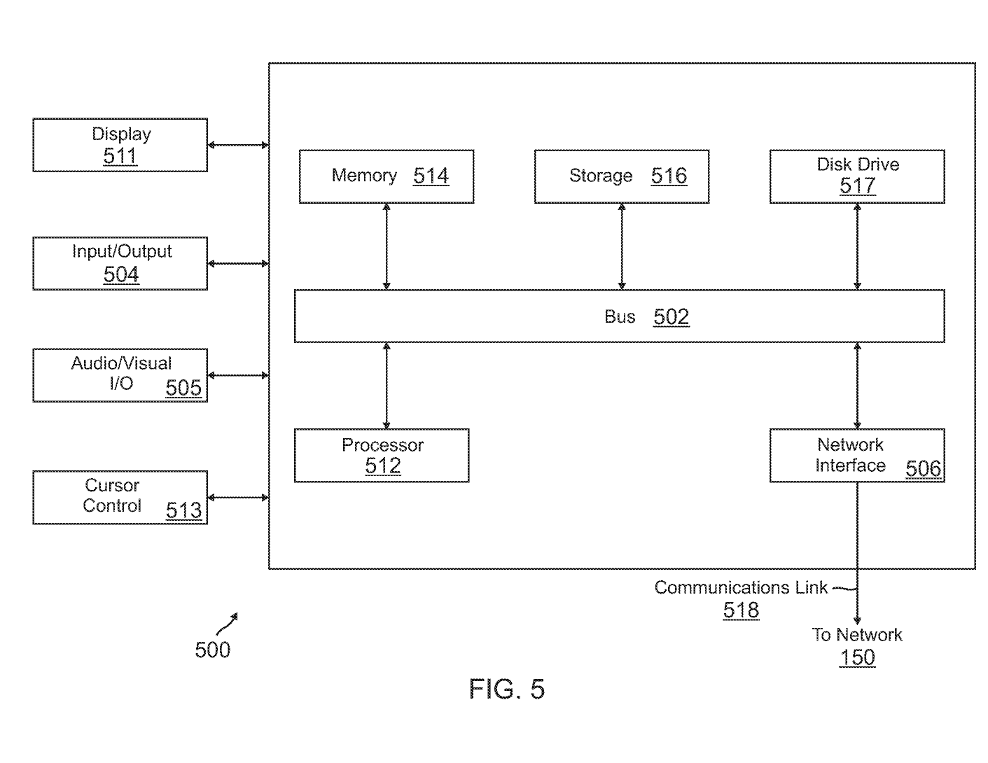

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A payment provider system, comprising:
a non-transitory memory storing payment account information for a plurality of payment accounts, wherein the plurality of payment accounts comprise a first payee account for a first payee, a second payee account for a second payee, and at least one payer account for at least one payer; and
one or more hardware processors coupled to the non-transitory memory and configured to read instructions from the non-transitory memory to cause the system to perform operations comprising:
receiving a first request to establish a group payment to at least the first payee and the second payee, wherein the first request comprises a first payment share of the group payment for the first payee and a second payment share of the group payment to the second payee;
generating a uniform resource locator (URL) address for the group payment using the first request, wherein the URL address provides access to a payment interface for the group payment;
providing the URL address for use by the first payee and the second payee to receive the group payment;
receiving a first payment request from the at least one payer for the group payment using the at least one payer account, wherein the first payment request is received by the payment provider system through the payment interface accessible using the URL address; and
processing the first payment request to provide a first payment to the first payee account based on the first payment share and a second payment to the second payee account based on the second payment share.

2. The system of claim 1, wherein the one or more hardware processors are further configured to read instructions from the non-transitory memory to cause the system to perform further operations comprising:
receiving a second payment request from at least one additional payer for the group payment; and
processing the second payment request to provide a third payment to the first payee account based on the first payment share and a fourth payment to the second payee account based on the second payment share.

3. The system of claim 1, wherein the one or more hardware processors are further configured to read instructions from the non-transitory memory to cause the system to perform further operations comprising:
receiving a second request to change the first payment share and the second payment share; and
updating the first payment share to a first new shared amount of the group payment; and
updating the second payment share to a second new shared amount of the group payment.

4. The system of claim 1, wherein the one or more hardware processors are further configured to read instructions from the non-transitory memory to cause the system to perform further operations comprising:
establishing a group payment account for the group payment,
wherein the first payment request is processed to receive a deposit for the first payment and the second payment in the group payment account.

5. The system of claim 4, wherein the first payee and the second payee is provided access to the group payment account by the payment provider system, wherein the first payee is allowed to withdraw up to the first payment share from the deposit in the group payment account, and wherein the second payee is allowed to withdraw up to the second payment share from the deposit the in group payment account.

6. The system of claim 4, wherein the processing the first payment request further comprises transferring the first payment for the first payment share to the first payee account from the group payment account and transferring the second payment for the second payment share to the second payee account from the group payment account.

7. The system of claim 1, wherein the at least one payer comprises a plurality of payers, wherein the at least one payer account comprises a plurality of payer accounts for the plurality of payers, wherein each of the plurality of payers owes a portion of the group payment, and wherein the first payment request is for a first amount owed by a first payer of the plurality of payers.

8. The system of claim 7, wherein the one or more hardware processors are further configured to read instructions from the non-transitory memory to cause the system to perform further operations comprising:
receiving a second payment request from a second payer based on a second amount owed by the second payer.

9. The system of claim 1, wherein first payment request is for a first item, and wherein the one or more hardware processors are further configured to read instructions from the non-transitory memory to cause the system to perform further operations comprising:
receiving at least one further group payment for a second item for the group payment, wherein payment interface is updated with a further group payment for the second item.

10. The system of claim 1, wherein the URL address comprises a web address for a payment webpage on a website of the payment provider system, wherein the payment interface of the payment webpage displays information for the group payment, and wherein the payment interface includes a payment processing field to submit the first payment request.

11. The system of claim 1, wherein the URL address causes an application interface to be opened in a dedicated application of the payment provider system executing on a device of the at least one payer, wherein the payment interface in the application interface displays information for the group payment, and wherein payment interface includes a payment processing field to submit the first payment request using the dedicated application.

12. The system of claim 1, wherein the providing the URL address comprises communicating the URL address to at least one of the first payee and the second payee, and wherein the at least one of the first payee and the second payee communicates the URL address to the at least one payer for payment.

13. The system of claim 12, wherein the at least one of the first payee and the second payee communicates the URL address from a first device of the at least one of the first payee and the second payee to a second device of the at least one payer using one of SMS messaging, MMS messaging, email, instant messaging, social networking messaging, microblogging, and short range wireless communications.

14. The system of claim 1, wherein the providing the URL address comprises communicating the URL address to the at least one payer by the payment provider system on request by at least one of the first payee and the second payee.

15. A method comprising:
receiving, by a payment provider system that comprises one or more hardware processors coupled to a non-transitory memory, a first request to establish a group payment to at least the first payee and the second payee, wherein the first request comprises a first payment share of the group payment for the first payee and a second payment share of the group payment to the second payee, and wherein the payment provider system provides a first payee account for the first payee and a second payee account for the second payee;
generating a uniform resource locator (URL) address for the group payment using the first request, wherein the URL address provides access to a payment interface for the group payment;
providing the URL address for use by the first payee and the second payee to receive the group payment;
receiving a first payment request from at least one payer for the group payment using .at least one payer account for the at least one payer, wherein the first payment request is received by the payment provider system through the payment interface accessible using the URL address; and
processing the first payment request to provide a first payment to the first payee account based on the first payment share and a second payment to the second payee account based on the second payment share.

16. The method of claim 15, wherein the payment interface comprises an setup process to establish payment accounts with the payment provider system, and wherein the at least one payer uses the setup process to establish the at least one payer account used to submit the first payment request.

17. The method of claim 15, wherein the at least one payer account comprises a debit card, a credit card, and a banking account with a financial institution other than the payment provider system.

18. The method of claim 15, wherein the first payment share and the second payment share are equal by default in the first request, and wherein the payment provider system provides a group payment interface to adjust a first amount of the first payment share and a second amount of the second payment share.

19. The method of claim 15, wherein the first request further comprises a payment breakdown for at least one item purchased by the first payee and the second payee, and wherein the method further comprises:
determining the first payment share and the second payment share using the payment breakdown, wherein the payment breakdown comprises a first contribution to the at least one item by the first payee and a second contribution to the at least one item by the second payee.

20. A non-transitory machine-readable medium having stored thereon machine-readable instructions executable to cause a machine to perform operations comprising:
receiving, by a payment provider system that comprises one or more hardware processors coupled to a non-transitory memory, a first request to establish a group payment to at least the first payee and the second payee, wherein the first request comprises a first payment share of the group payment for the first payee and a second payment share of the group payment to the second payee, and wherein the payment provider system provides a first payee account for the first payee, a second payee account for the second payee, and at least one payer account for at least one payer;
generating a uniform resource locator (URL) address for the group payment using the first request, wherein the URL address provides access to a payment interface for the group payment;
providing the URL address for use by the first payee and the second payee to receive the group payment;
receiving a first payment request from the at least one payer for the group payment using the at least one payer account, wherein the first payment request is received by the payment provider system through the payment interface accessible using the URL address; and
processing the first payment request to provide a first payment to the first payee account based on the first payment share and a second payment to the second payee account based on the second payment share.
